(19) United States
(12) Patent Application Publication
(10) Pub. No.: US 2025/0108648 A1
(43) Pub. Date: Apr. 3, 2025

(54) HOUSING UNIT, RECORDING DEVICE, AND MAINTAINING METHOD

(71) Applicant: SEIKO EPSON CORPORATION, Tokyo (JP)

(72) Inventor: Keiichiro FUKUMASU, KITAKYUSHU-SHI (JP)

(21) Appl. No.: 18/903,215

(22) Filed: Oct. 1, 2024

(30) Foreign Application Priority Data
Oct. 3, 2023 (JP) 2023-171914

(51) Int. Cl. B41J 29/13; B41J 3/44; H04N 1/00

(52) U.S. Cl. CPC B41J 29/13; B41J 3/44; H04N 1/00551; H04N 1/00559

(57) ABSTRACT

A housing structure includes a housing including an opening, and a scanner unit configured to rotate relative to the housing with a rotational movement shaft being a center to switch a posture to a closing posture and an opening posture. The opening is closed in the closing posture and open in the opening posture. The scanner unit includes a protruding portion. The housing includes a support portion. As the scanner unit is opened at 52° or more from the closing posture, the protruding portion together with the scanner unit is able to move in a direction along the rotational movement shaft. As the protruding portion moves in a direction along the rotational movement shaft, the protruding portion and the support portion engage with each other. Upon the protruding portion and the support portion engaging with each other, the scanner unit is maintained in the opening posture.

The present application is based on, and claims priority from JP Application Serial Number 2023-171914, filed Oct. 3, 2023, the disclosure of which is hereby incorporated by reference herein in its entirety.

### BACKGROUND

### 1. Technical Field

The present disclosure relates to a housing unit, a recording device, and a maintaining method.

### 2. Related Art

JP-A-2021-190873 describes a printer in which a scanner unit is disposed at an upper side of a housing. In this printer, the scanner unit is able to be opened and closed with respect to the housing. At the time of performing maintenance or the like, by opening the scanner unit toward the upper side, it is possible to access the inside of the housing. In addition, this printer includes a supporting rod used to maintain the scanner unit in a state of being opened in order to improve the workability at the time of performing maintenance or the like.

However, in a case of the printer described in JP-A-2021-190873, the supporting rod supports an end portion of the scanner unit disposed at the open side, that is, at the end portion that moves up and down at the time of opening and closing. Thus, depending on details of work, there is a case in which the supporting rod blocks access to the inside of the housing.

### SUMMARY

A housing unit includes a housing including an opening, and an opening/closing section configured to rotate relative to the housing with a rotational movement shaft being a center to switch a posture to a closing posture and a first opening posture, the closing posture being a posture in which the opening of the housing is closed, the first opening posture being a posture in which the opening of the housing is opened, in which the opening/closing section includes a first engaging portion, the housing includes a second engaging portion, by opening the opening/closing section at a first angle or more from the closing posture, the first engaging portion or the second engaging portion moves in a direction along the rotational movement shaft to enable the first engaging portion and the second engaging portion to engage with each other, and upon the first engaging portion and the second engaging portion engaging with each other, the opening/closing section is maintained in the first opening posture.

A recording device includes the housing unit described above and a recording unit accommodated in the housing and configured to perform recording on a medium.

A method of maintaining an opening/closing section in a first opening posture, the opening/closing section being configured to rotate relative to a housing including an opening with a rotational movement shaft being a center to switch a posture to a closing posture and the first opening posture, the closing posture being a posture in which the opening of the housing is closed, the first opening posture being a posture in which the opening of the housing is opened, the method including opening the opening/closing section at a first angle or more from the closing posture, moving the opening/closing section in a direction along the rotational movement shaft in a state in which the opening/closing section is opened at the first angle or more, and causing a first engaging portion and a second engaging portion to engage with each other in a state in which the opening/closing section is moved in a direction along the rotational movement shaft, the first engaging portion being included in the opening/closing section, the second engaging portion being included in the housing.

### BRIEF DESCRIPTION OF THE DRAWINGS

FIG. 1 is a perspective view of a printer.

FIG. 2 is a plan view of the printer.

FIG. 3 is a perspective view of the printer in a state in which a scanner unit is opened at 25°.

FIG. 4 is a perspective view of the printer in a state in which the scanner unit is opened at 45°.

FIG. 5 is a perspective view of the printer in a state in which the scanner unit is detached.

FIG. 6 is a perspective view when the scanner unit is viewed from the bottom surface side.

FIG. 7 is a perspective view in which a first support portion of the housing and its surroundings are enlarged.

FIG. 8 is a perspective view in which a first protruding portion of the scanner unit and its surroundings are enlarged.

FIG. 9 is a cross-sectional view of an open-close mechanism when the open angle is 25°.

FIG. 10 is a cross-sectional view of the open-close mechanism when the open angle is 55°.

FIG. 11 is a cross-sectional view of the open-close mechanism when the open angle is 25°.

FIG. 12 is a cross-sectional view of the open-close mechanism when the open angle is 55°.

FIG. 13 is a cross-sectional view of the open-close mechanism in a state in which the scanner unit is opened to 55° and is moved in the +X direction.

FIG. 14 is a cross-sectional view of the open-close mechanism in a state in which the scanner unit is moved in the +X direction, and then is caused to descend.

FIG. 15 is a cross-sectional view of the first support portion and its surroundings when the open angle is 45°.

FIG. 16 is a cross-sectional view of a second support portion and its surroundings when the open angle is 45°.

FIG. 17 is a flowchart used to explain a method for maintaining the scanner unit in an opening posture with the open angle being 45°.

### DESCRIPTION OF EMBODIMENTS

Below, a printer 1 according to the present embodiment will be described.

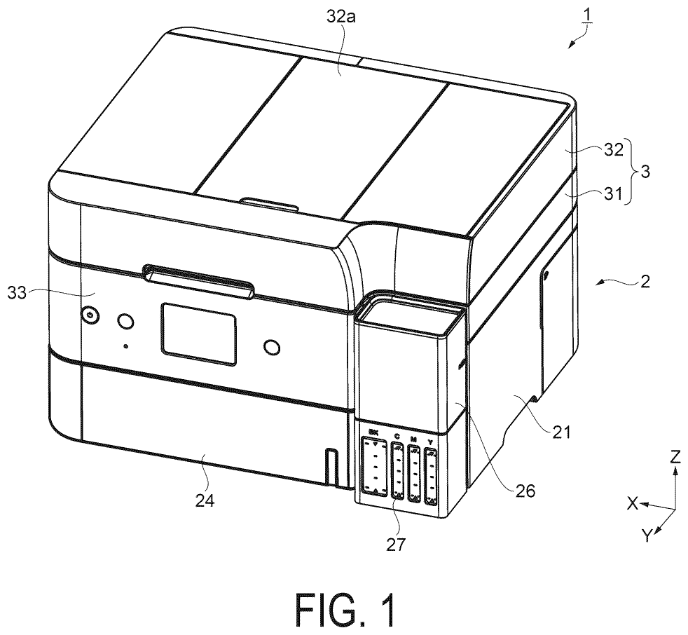

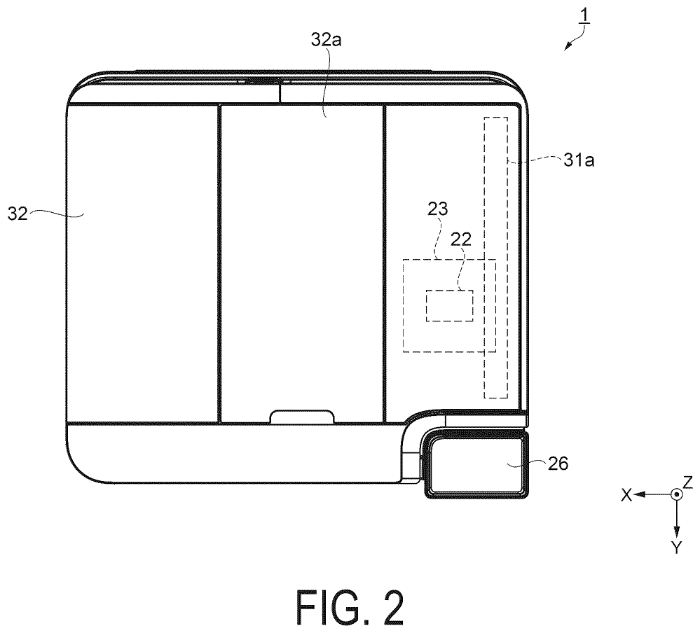

FIG. 1 is a perspective view of the printer 1. FIG. 2 is a plan view of the printer 1.

The printer 1 is an inkjet printer configured to discharge a liquid typified by ink on a medium typified by a recording sheet, thereby performing recording. The printer 1 serves as one example of a recording device.

Each of the drawings illustrates the X-axis, the Y-axis, and the Z-axis that are perpendicular to each other. The X-axis is parallel to an installation surface of the printer 1 and corresponds to the width direction of the printer 1. The Y-axis is parallel to the installation surface of the printer 1, and corresponds to a depth direction of the printer 1. The Z-axis is perpendicular to the installation surface of the printer 1, and corresponds to a height direction of the printer 1.

Hereinafter, the +X direction parallel to the X-axis is the left direction when the printer 1 is viewed from the front. The −X direction parallel to the X-axis is the direction opposite from the +X direction. The +Y direction parallel to the Y-axis is a direction from the back surface of the printer 1 toward the front face. The −Y direction parallel to the Y-axis is the direction opposite from the +Y direction. The +Z direction parallel to the Z-axis is a direction extending upward from the installation surface of the printer 1. The −Z direction parallel to the Z-axis is the direction opposite from the +Z direction.

The printer 1 is a multifunction device including an apparatus body 2 and a scanner unit 3. The scanner unit 3 is disposed at an upper portion of the apparatus body 2. The scanner unit 3 serves as one example of a reading device configured to read an original document. The apparatus body 2 including a box-shaped housing 21, and various types of components are provided inside of and outside of the housing 21. The apparatus body 2 and the scanner unit 3 are configured so as to be substantially flush with each other at individual side surfaces in the +X direction and +Y direction.

The apparatus body 2 has a function of performing recording on a medium. The scanner unit 3 has a function of reading an original document. The apparatus body 2 includes an ink discharging head 22 serving as one example of a recording unit. The ink discharging head 22 discharges ink serving as one example of a liquid to perform recording on a medium. The ink discharging head 22 is provided at a carriage 23 configured to move in the +X direction. The ink discharging head 22 is supplied with ink through an ink tube (not illustrated) from an ink accommodation unit 26 serving as one example of a liquid accommodation unit that will be described later.

The scanner unit 3 includes a unit main body 31 and an original-document feeding device 32. The upper surface of the unit main body 31 constitutes an original-document table (not illustrated) comprised of a glass plate or the like. The unit main body 31 includes a reading sensor 31a extending in the +Y direction below the original-document table. In the present embodiment, the reading sensor 31a is comprised of a contact image sensor (CIS), and reads an original document mounted at the original-document table while moving in the +X direction.

The original-document feeding device 32 is disposed above the unit main body 31. The original-document feeding device 32 is coupled to the unit main body 31 through a hinge (not illustrated) provided at the back surface side of the printer 1. A rotational movement shaft of the hinge is provided parallel to the +X direction. The original-document feeding device 32 is configured to be opened and closed with respect to the unit main body 31 with this hinge. By opening the original-document feeding device 32 to expose the original-document table, a user is able to set an original document at the original-document table or remove the original document.

A top surface cover 32a configured to be opened and closed is disposed at the upper surface of the original-document feeding device 32. When the original-document feeding device 32 is used to read an original document, the original document is set at a paper feed port (not illustrated) exposed when the top surface cover 32a is opened, and is transported above the original-document table. The reading sensor 31a reads the transported original document in a state of being stopped at an end portion, at the +X direction, of the original-document table. In this case, a first surface of the original document is read by the reading sensor 31a, and a second surface, which is an opposite from the first surface, is read by a reading sensor (not illustrated) provided within the original-document feeding device 32.

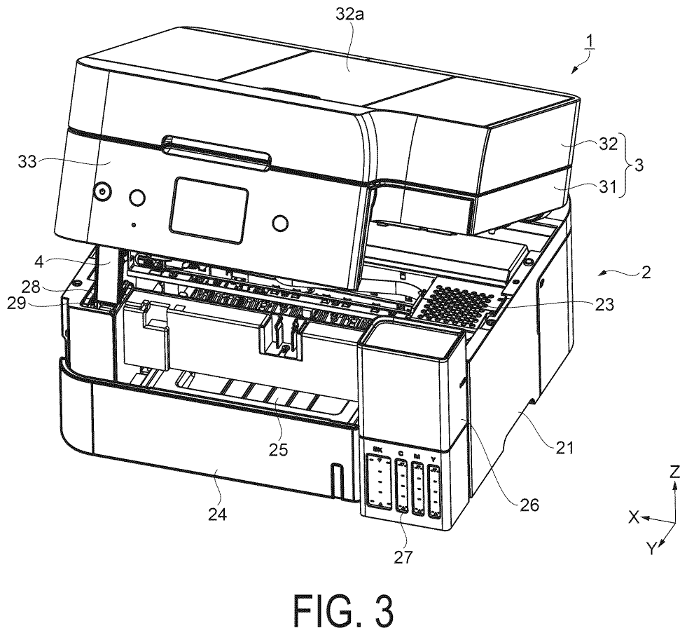

An operating panel 33 used to perform various types of setting operations is provided at the front face of the printer 1. In the present embodiment, the operating panel 33 is supported by the unit main body 31 of the scanner unit 3, rather than by the apparatus body 2 (see FIG. 3). However, the operating panel 33 may be provided at the apparatus body 2. The apparatus body 2 includes a front face cover 24 disposed at the lower side of the operating panel 33 and configured to be opened and closed. Upon the front face cover 24 being opened, a paper discharge tray 25 (see FIG. 3) and a medium accommodation cassette (not illustrated) emerge, the paper discharge tray 25 being configured to receive a medium ejected after recording is performed, the medium accommodation cassette being disposed at the lower side of the paper discharge tray 25.

A plurality of media before recording are accommodated in the medium accommodation cassette. The medium accommodated in the medium accommodation cassette is sent out toward the −Y direction by a feeding roller (not illustrated), and is reversed. Then, recording is performed on the medium while the medium is being transported in the +Y direction. After this, the medium is ejected onto the paper discharge tray 25. Note that the front face cover 24 in a state of being closed and the operating panel 33 are substantially flush with each other as illustrated in FIG. 1.

The ink accommodation unit 26 serving as one example of a liquid accommodation unit is provided at the −X side of the front face of the apparatus body 2. A plurality of ink tanks (not illustrated) are provided inside of the ink accommodation unit 26, and ink with different colors is accommodated in individual ink tanks. A remaining-amount indicator 27 that makes it possible to visually recognize the remaining amount of each ink is provided at the lower side of the ink accommodation unit 26.

FIG. 3 is a perspective view of the printer 1 in a state in which the scanner unit 3 is opened.

As illustrated in FIG. 3, the printer 1 according to the present embodiment is configured such that the scanner unit 3 is able to be opened and closed relative to the apparatus body 2, that is, the housing 21. The housing 21 includes an opening that faces upward, that is, faces the +Z direction. In addition to the ink discharging head 22 and the carriage 23 described above, the housing 21 accommodates a movement mechanism (not illustrated) configured to move the carriage 23 in the +X direction, a transport mechanism (not illustrated) configured to transport a medium, and the like. By opening the scanner unit 3, the opening of the housing 21 is opened, which enables access to the inside of the housing 21 through the opening. In addition, by closing the scanner unit 3, the opening of the housing 21 is closed.

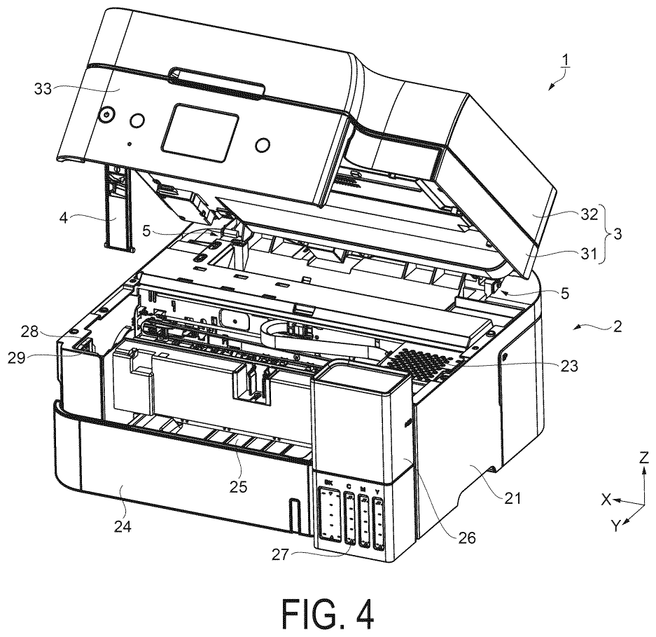

When a paper jam occurs within the housing 21, a user is able to open the scanner unit 3 and remove the jammed paper by himself or herself. An open-close mechanism 5 (see FIG. 4) used to open and close the scanner unit 3 is provided at the back side, that is, at the −Y side of the housing 21. By lifting the end portion at the front face side, that is, at the +Y side of the scanner unit 3, it is possible to open the scanner unit 3. The open-close mechanism 5 is a mechanism used to rotate the scanner unit 3 about a rotational movement shaft along the +X direction. In other words, the scanner unit 3 rotates relative to the housing 21 with the rotational movement shaft being the center, thereby being able to switch a posture to a closing posture in which the opening of the housing 21 is closed and an opening posture in which the opening of the housing 21 is opened. The scanner unit 3 serves as one example of an opening/closing section. In addition, a structure including the housing 21 and the scanner unit 3 configured to be opened and closed relative to the housing 21 serves as one example of a housing structure.

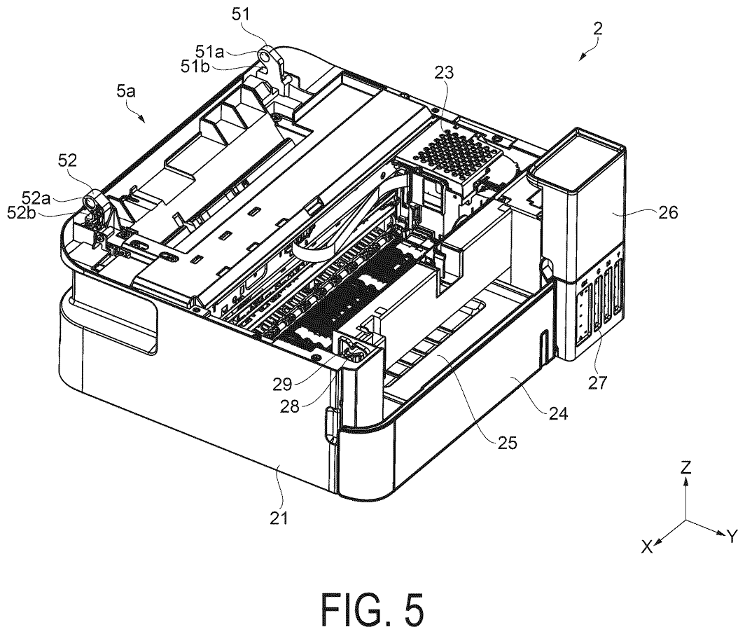

The printer 1 includes a maintaining plate 4 having a long plate shape and extending in the vertical direction. The housing 21 and the scanner unit 3 are coupled to each other through the maintaining plate 4. In other words, the maintaining plate 4 is coupled to both the housing 21 and the scanner unit 3. The maintaining plate 4 is disposed at an end portion, at the +Y direction, of the printer 1 and at an end portion, at the +X direction, of the printer 1. Thus, it is possible to prevent the maintaining plate 4 from blocking access to the inside of the housing 21, as compared with a case in which the maintaining plate 4 is disposed at the center in the +X direction. The upper end of the maintaining plate 4 is supported so as to be able to rotate relative to the scanner unit 3 about the rotational movement shaft along the +X direction. The lower end of the maintaining plate 4 is disposed inside of the apparatus body 2 in a state in which the scanner unit 3 is closed. In addition, when the scanner unit 3 is opened at a predetermined angle, the lower end of the maintaining plate 4 is locked by a lock unit 28 (see FIGS. 3 and 5) provided at the housing 21, whereby the scanner unit 3 cannot be opened so as to exceed this angle. In other words, the maintaining plate 4 limits opening of the scanner unit 3 to the predetermined angle.

When the scanner unit 3 is opened at approximately the predetermined angle described above and then is caused to slightly descend, the lower end of the maintaining plate 4 is guided by the lock unit 28 so as to be positioned above a maintaining-plate support portion 29 (see FIGS. 3 and 5) provided at the housing 21. At this time, the scanner unit 3 is supported by the maintaining-plate support portion 29 through the maintaining plate 4. In this state, the scanner unit 3 is maintained in an opened state even if a user does not keep lifting it. Thus, a user is able to perform operations such as removing a medium or the like by using both hands. In the present embodiment, the open angle of the scanner unit 3 is approximately 25° when the scanner unit 3 is maintained by the maintaining plate 4. The open angle represents an angle at which the scanner unit 3 rotates from the closing posture. A posture of the scanner unit 3 when the open angle is approximately 25° serves as one example of a second opening posture. In addition, the maintaining plate 4 serves as one example of a holding unit configured to maintain the scanner unit 3 in the second opening posture. The second opening posture is a posture in which the open angle of the scanner unit 3 is smaller than a first opening posture that will be described later.

After the operation is complete, when the user slightly lifts the scanner unit 3, the lower end of the maintaining plate 4 is guided by the lock unit 28 from above the maintaining-plate support portion 29 to a position at which the lower portion is opened. In this state, when the user causes the scanner unit 3 to descend, the maintaining plate 4 moves downward within the housing 21, and is brought into a state in which the scanner unit 3 is closed.

As described above, the printer 1 according to the present embodiment makes it possible to maintain the scanner unit 3 at the open angle of approximately 25° such that a user is able to perform light work. In addition, the printer 1 is able to open the scanner unit 3 at an open angle sufficiently larger than 25° such that an operator or the like from a manufacturer is able to perform more complicated maintenance work or repair operation or the like. In other words, the operation performed at the open angle of approximately 25° is assumed to be an operation performed by a user, and the operation performed at an open angle larger than 25° is assumed to be an operation performed by an operator from a manufacturer or the like.

The maintaining plate 4 is made of synthetic resin, for example. The maintaining plate 4 has rigidity with which the scanner unit 3 can be supported, and at the same time, has elasticity with which the maintaining plate 4 can be torsionally deformed about the longitudinal direction as an axis. When an operator twists the lower end side of the maintaining plate 4 in a state in which the scanner unit 3 is lifted up until the opening angle becomes approximately 25°, the locking by the lock unit 28 is released. In other words, the maintaining plate 4 is detachable with respect to the housing 21. In addition, by detaching the maintaining plate 4 from the housing 21, it is possible to open the scanner unit 3 at an open angle larger than 25°.

FIG. 4 is a perspective view of the printer 1 in a state in which the scanner unit 3 is opened at 45°.

As illustrated in FIG. 4, when the scanner unit 3 is opened at 45°, access to the inside of the apparatus body 2 becomes easier, as compared with a case of 25°. In addition, the maintaining plate 4 is in a state in which the lower end thereof is detached from the housing 21, and is in a state of extending downward from the scanner unit 3. The open-close mechanism 5 configured to open and close the scanner unit 3 is provided at the back side, that is, at the −Y side of the printer 1.

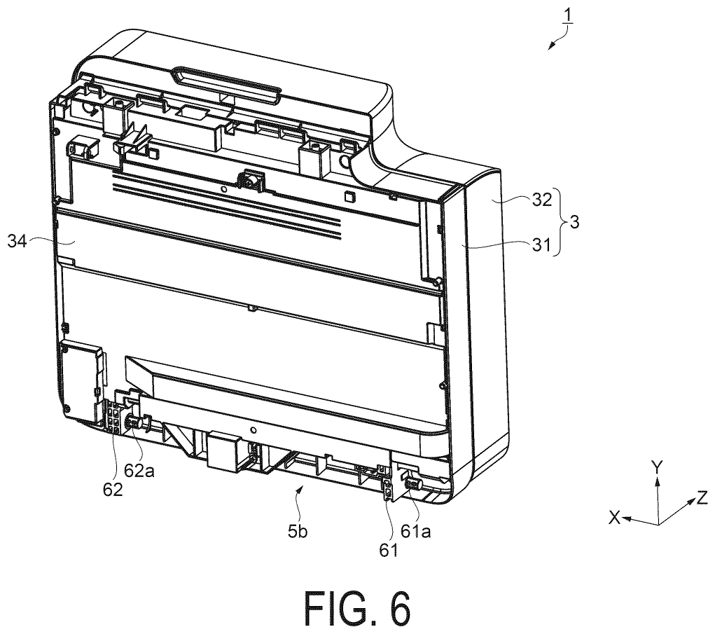

FIG. 5 is a perspective view of the printer 1, that is, the apparatus body 2 in a state in which the scanner unit 3 is detached. In addition, FIG. 6 is a perspective view when the scanner unit 3 is viewed from the bottom surface side. Note that the coordinate system axes illustrated in FIG. 6 are coordinate system axes in a case where the scanner unit 3 is closed. After this, when the shape or the like of the scanner unit 3 is described, description will be made by using these coordinate system axes.

As illustrated in FIGS. 5 and 6, the open-close mechanism 5 includes a fixed-side mechanism 5a provided at the housing 21, and a movable-side mechanism 5b provided at the scanner unit 3.

As illustrated in FIG. 5, the fixed-side mechanism 5a includes a first support portion 51 and a second support portion 52 that protrude toward the +Z direction as a whole. The first support portion 51 and the second support portion 52 are spaced apart from each other in the +X direction. The second support portion 52 is disposed more toward the +X direction than the first support portion 51. A through hole 51a penetrating in the +X direction is formed at an end portion, at the +Z side, of the first support portion 51. In addition, an opening portion 52a having a recessed shape that is recessed toward the −X direction is formed at the +X-side surface of an end portion, at the +Z side, of the second support portion 52. That is, the housing 21 includes the through hole 51a and the opening portion 52a. The shape of each of the through hole 51a and the opening portion 52a is a circular shape when viewed from the +X side. The through hole 51a and the opening portion 52a each serve as one example of a bearing unit. In addition, recessed portions 51b and 52b having a substantially letter-U shape that is recessed toward the +Y direction are formed at a surface, at the −Y side, of the first support portion 51 and at a surface, at the −Y side, of the second support portion 52, respectively.

As illustrated in FIG. 6, the scanner unit 3 includes a supporting member 34 having a plate shape and constituting a bottom of the unit main body 31. The supporting member 34 includes a first protruding portion 61 and a second protruding portion 62 disposed at the back side, that is, at the −Y side and protruding toward the −Y direction. The first protruding portion 61 and the second protruding portion 62 are provided integrally with the scanner unit 3, and constitute the movable-side mechanism 5b. The first protruding portion 61 and the second protruding portion 62 are spaced apart from each other in the +X direction. The second protruding portion 62 is disposed more toward the +X direction than the first protruding portion 61. A cylindrical-shape first shaft section 61a protruding toward the −X direction is formed at the −X-side surface of the end portion, at the −Y side, of the first protruding portion 61. In addition, a cylindrical-shape second shaft section 62a protruding toward the −X direction is formed at the −X-side surface of the end portion, at the −Y side, of the second protruding portion 62. That is, the scanner unit 3 includes the first shaft section 61a protruding from the first protruding portion 61, and also includes the second shaft section 62a protruding from the second protruding portion 62. The first shaft section 61a and the second shaft section 62a each serve as one example of a shaft portion, and constitutes a rotational movement shaft used to open and close the scanner unit 3. Furthermore, the +X direction corresponds to a direction along the rotational movement shaft.

In a state in which the scanner unit 3 is attached to the apparatus body 2, the first protruding portion 61 of the scanner unit 3 is disposed at the +X side of the first support portion 51 of the housing 21, and the second protruding portion 62 of the scanner unit 3 is disposed at the +X side of the second support portion 52 of the housing 21. In addition, the first shaft section 61a fits into the through hole 51a formed in the first support portion 51, and the second shaft section 62a fits into the opening portion 52a in the second support portion 52. By opening and closing the scanner unit 3, the first shaft section 61a slides in the circumferential direction with respect to the inner surface of the through hole 51a, and the second shaft section 62a slides in the circumferential direction with respect to the inner surface of the opening portion 52a.

The open-close mechanism 5 according to present embodiment includes a maintaining mechanism configured to maintain opening of the scanner unit 3 at 45°. This maintaining mechanism eliminates the need for an operator to support the scanner unit 3 in a state in which the scanner unit 3 is more opened than the second opening posture, which makes it possible to easily perform maintenance or repair.

Specifically, after detaching the maintaining plate 4 from the housing 21, the operator lifts up the scanner unit 3 to bring the open angle of the scanner unit 3 to not less than 52°. This causes the scanner unit 3 to become movable toward the +X direction relative to the apparatus body 2. Then, after the scanner unit 3 is moved by a predetermined distance toward the +X direction and the scanner unit 3 is caused to descend, a portion of the fixed-side mechanism 5a and a portion of the movable-side mechanism 5b engage with each other, and the scanner unit 3 is maintained in a posture with the open angle being approximately 45°. The posture of the scanner unit 3 when the open angle thereof is approximately 45° serves as one example of a first opening posture. In this manner, the scanner unit 3 according to the present embodiment makes it possible to switch its posture to a closing posture in which the open angle is 0°, a second opening posture in which the open angle is approximately 25°, and a first opening posture in which the open angle is approximately 45°.

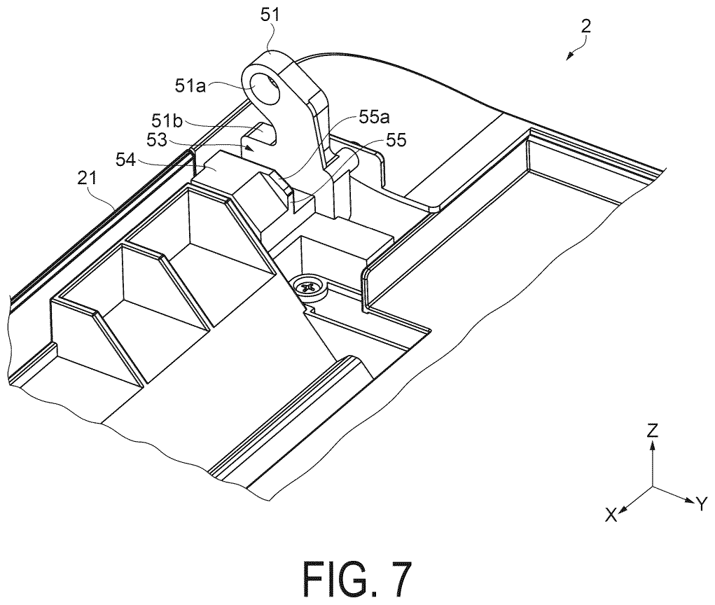

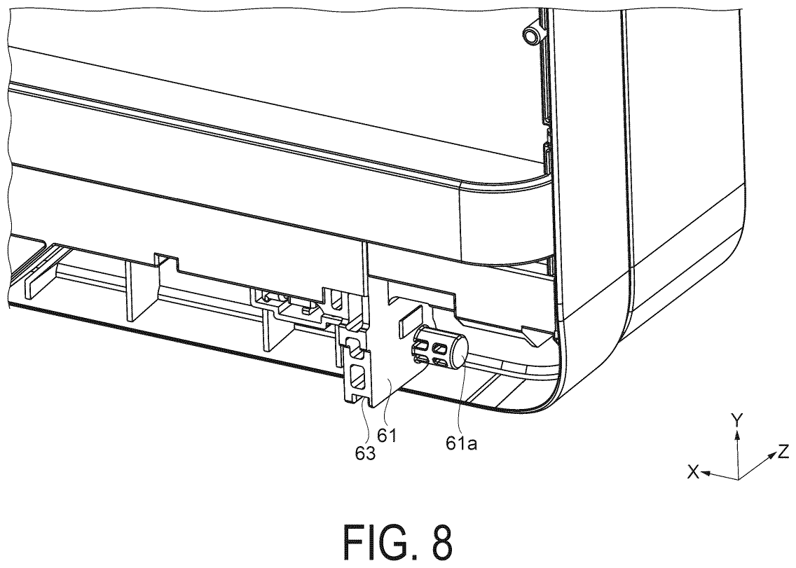

FIG. 7 is a perspective view in which the first support portion 51 of the housing 21 and its surroundings are enlarged. FIG. 8 is a perspective view in which the first protruding portion 61 of the scanner unit 3 and its surroundings are enlarged.

As illustrated in FIG. 7, a third support portion 54 configured integrally with the housing 21 is provided at the +X side of the first support portion 51 with a space 53 being interposed between them. In other words, the housing 21 includes the third support portion 54. The third support portion 54 includes a protruding portion 55 formed at the −X side thereof. The protruding portion 55 has a plate shape formed substantially parallel to the YZ plane, and protrudes in a direction having a +Y component and a +Z component. Furthermore, the protruding portion 55 includes a sloped surface 55a having a protruding direction being a normal-line direction. At the protruding portion 55, the third support portion 54 is able to engage with the first protruding portion 61 included in the scanner unit 3. The first protruding portion 61 serves as one example of a first engaging portion. The third support portion 54 serves as one example of a second engaging portion.

As illustrated in FIG. 8, a recess-shaped groove 63 recessed in the +Y direction and extending in the +Z direction is formed at an end portion, at the −Y direction, of the first protruding portion 61 included in the scanner unit 3. As the protruding portion 55 enters this groove 63, the first protruding portion 61 engages with the third support portion 54. The width, that is, the dimension in the +X direction of the groove 63 is larger than the width, that is, the dimension in the +X direction of the protruding portion 55.

In addition, the width, that is, the dimension in the +X direction of the first protruding portion 61 is smaller than the width, that is, the dimension in the +X direction of the space 53 between the first support portion 51 and the third support portion 54. The first protruding portion 61 is normally disposed in this space 53, and the scanner unit 3 is opened and closed in a state in which the first protruding portion 61 is disposed in this space 53.

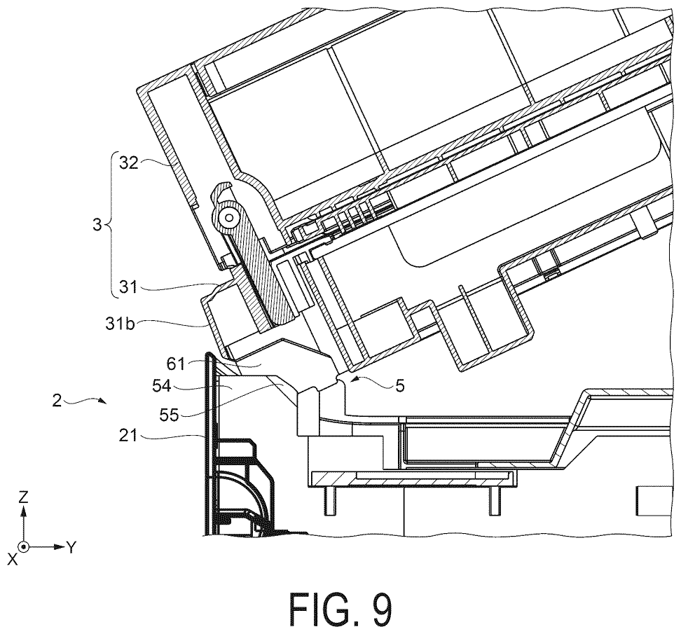

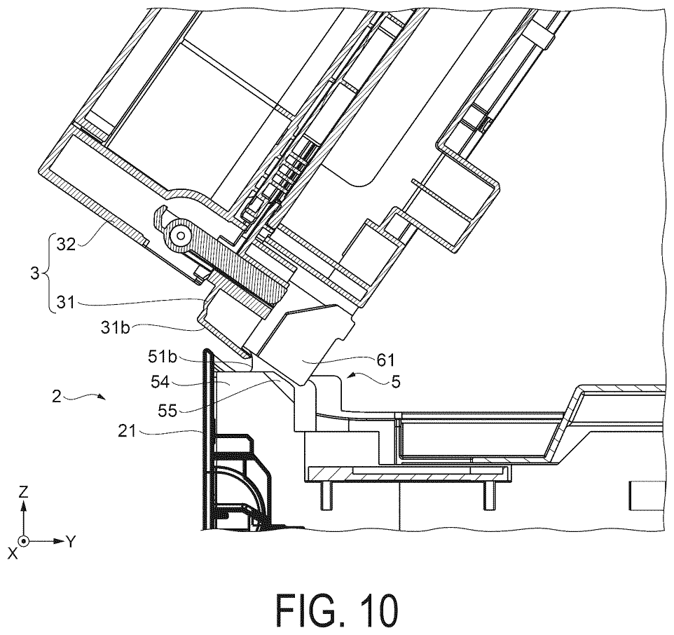

FIG. 9 is a cross-sectional view of the open-close mechanism 5 when the open angle is 25°. FIG. 10 is a cross-sectional view of the open-close mechanism 5 when the open angle is 55°.

As illustrated in FIG. 9, when the open angle of the scanner unit 3 is smaller than 52°, the first protruding portion 61 of the scanner unit 3 is interposed between the first support portion 51 and the third support portion 54 of the housing 21. In other words, the first protruding portion 61 overlaps with the third support portion 54 as viewed from the +X side, and hence, the scanner unit 3 is not able to move toward the +X direction. In addition, as illustrated in FIG. 10, when the open angle of the scanner unit 3 is not less than 52°, the first protruding portion 61 of the scanner unit 3 does not overlap with the third support portion 54 as viewed from the +X side. In other words, the scanner unit 3 is released from restriction by the third support portion 54, and is able to move toward the +X direction. In this manner, in a state in which the scanner unit 3 is not opened at 52° or more from the closing posture, the first protruding portion 61 and the third support portion 54 interfere with each other, which results in restriction of movement of the scanner unit 3 toward the +X direction. In addition, in a state of being opened at 52° or more from the closing posture, the scanner unit 3 is able to move toward the +X direction. The “52°” is one example of a first angle.

In addition, as illustrated in FIG. 10, when opening of the scanner unit 3 reaches 55°, a cover member 31b that constitutes the back surface of the unit main body 31 comes into contact with the recessed portion 51b of the first support portion 51 and the recessed portion 52b of the second support portion 52. Thus, the scanner unit 3 is not able to open at an angle larger than 55°. In other words, the cover member 31b, the first support portion 51, and the second support portion 52 each serve as one example of a restricting unit configured to restrict opening of the scanner unit 3 at 55° or more. The “55°” that is an angle larger than 52° serves as one example of a second angle.

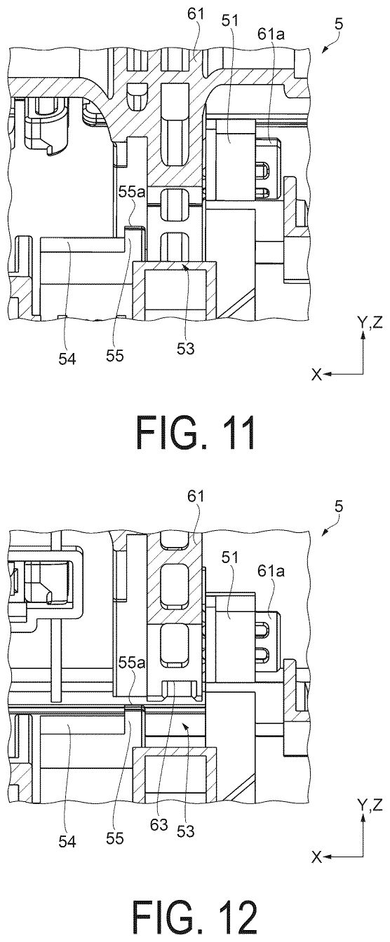

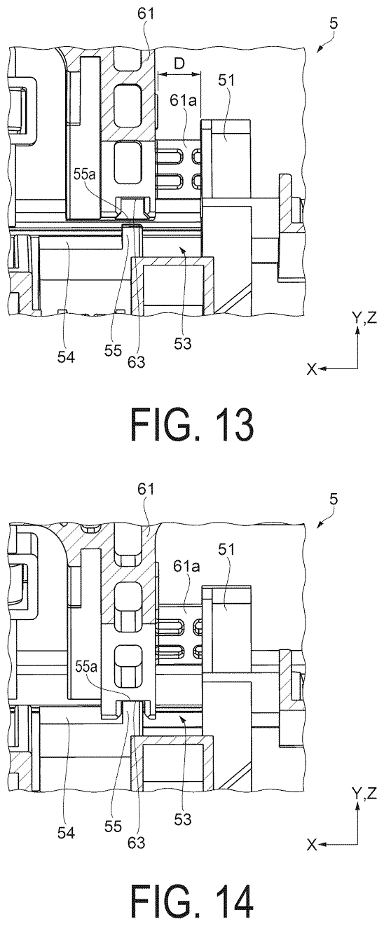

FIGS. 11 to 14 are cross-sectional views each illustrating the open-close mechanism 5 as viewed up from the front along the sloped surface 55a. FIG. 11 is a diagram when the open angle is 25°. FIG. 12 is a diagram when the open angle is 55°. FIG. 13 is a diagram in a state in which opening of the scanner unit 3 is at 55° and is moved in the +X direction. FIG. 14 is a diagram in a state in which the scanner unit 3 is moved in the +X direction, and then is caused to descend.

As illustrated in FIG. 11, when the open angle falls in a range of not less than 0° and less than 52°, the first protruding portion 61 is interposed between the first support portion 51 and the third support portion 54, and hence, is not able to move in the +X direction. As illustrated in FIG. 12, when an operator opens the scanner unit 3 until the open angle reaches not less than 52°, the +X side of the first protruding portion 61 is opened, and hence, the scanner unit 3 becomes movable toward the +X direction. As illustrated in FIG. 13, when the operator moves the scanner unit 3 toward the +X direction by a predetermined distance D, the first protruding portion 61 together with the scanner unit 3 moves toward the +X direction by the distance D. In addition, the groove 63 of the first protruding portion 61 and the protruding portion 55 of the third support portion 54 are opposed to each other, and the first protruding portion 61 and the third support portion 54 are brought into a state of being able to engage with each other. After this, as illustrated in FIG. 14, when the scanner unit 3 is caused to descend from this state, the first protruding portion 61 and the third support portion 54 engage with each other. This makes it possible to cause the scanner unit 3 to be supported by the housing 21 through the first protruding portion 61 and the third support portion 54. At this time, the open angle of the scanner unit 3 is approximately 45°. In other words, without being supported by the operator, the scanner unit 3 is maintained in a posture with the open angle being 45° (see FIG. 4).

In this manner, with the printer 1 according to the present embodiment, by opening the scanner unit 3 at 52° or more from the closing posture, it is possible to move the first protruding portion 61 toward the +X direction. In addition, by moving the first protruding portion 61 toward the +X direction by the distance D, it is possible to cause the first protruding portion 61 and the third support portion 54 to engage with each other. Furthermore, as the first protruding portion 61 and the third support portion 54 engage with each other, the scanner unit 3 is maintained in a posture with the open angle being 45°.

In a state in which the first protruding portion 61 and the third support portion 54 engage with each other, the protruding portion 55 of the third support portion 54 enters the groove 63 of the first protruding portion 61. Thus, when the scanner unit 3 is moved in the +X direction in this state, the side surface of the protruding portion 55 comes into contact with the inner wall of the groove 63. In other words, the first protruding portion 61 and the third support portion 54 interfere with each other. Thus, movement of the scanner unit 3 toward the +X direction is restricted.

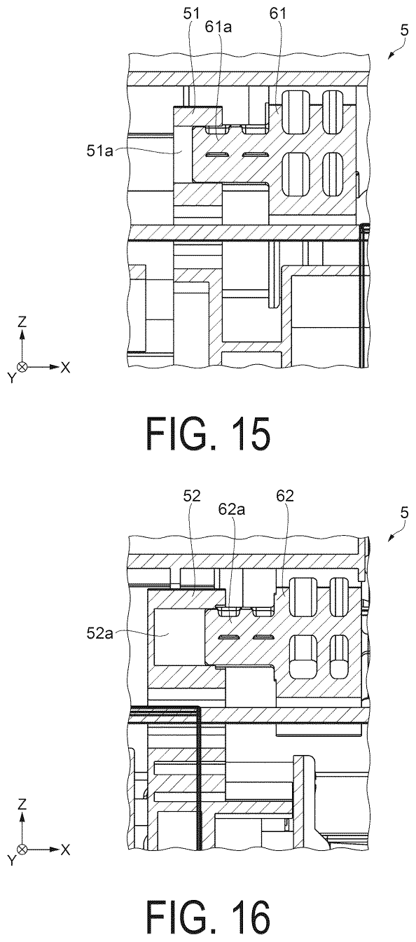

FIGS. 15 and 16 are cross-sectional views when the open-close mechanism 5 is viewed from the back surface side when the open angle is 45°. FIG. 15 is a diagram illustrating the first support portion 51 and its surroundings. FIG. 16 is a diagram illustrating the second support portion 52 and its surroundings.

As illustrated in FIG. 15, the first shaft section 61a is maintained in a state of fitting into the through hole 51a even in a state in which the scanner unit 3 moves toward the +X direction by the distance D and the first protruding portion 61 and the third support portion 54 engage with each other. Similarly, as illustrated in FIG. 16, the second shaft section 62a is maintained in a state of fitting into the opening portion 52a even in a state in which the first protruding portion 61 and the third support portion 54 engage with each other. Thus, even in a state in which the scanner unit 3 is moved toward the +X direction by the distance D, it is possible to stably perform an operation of opening and closing the scanner unit 3.

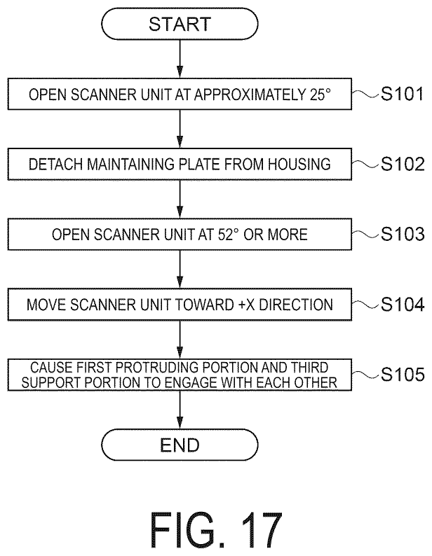

FIG. 17 is a flowchart used to explain a method for maintaining the scanner unit 3 in the opening posture with the open angle being 45°.

As illustrated in FIG. 17, an operator first lifts up the scanner unit 3 in the closing posture to open the scanner unit 3 until the open angle from the closing posture reaches approximately 25° (step S101). Then, the maintaining plate 4 is twisted to detach the maintaining plate 4 from the housing 21 (step S102). After this, the operator further lifts up the scanner unit 3 to open the scanner unit 3 until the open angle from the closing posture reaches not less than 52° (step S103). Next, the operator moves the scanner unit 3 toward the +X direction by the distance D in a state in which the scanner unit 3 is opened at 52° or more (step S104). Finally, in a state in which the scanner unit 3 is moved toward the +X direction by the distance D, the scanner unit 3 is caused to descend to cause the first protruding portion 61 and the third support portion 54 to engage with each other (step S105). With these operations, the scanner unit 3 is maintained in a state in which the open angle is 45°.

After performing a necessary operation such as maintenance or repair, the operator performs operations in reverse to those described above, thereby returning the scanner unit 3 to the closed state. That is, in a state in which the open angle of the scanner unit 3 is maintained at 45° (see FIG. 14), the operator lifts up the scanner unit 3 until the open angle reaches not less than 52° (see FIG. 13), and moves it toward the −X direction (see FIG. 12). Then, the operator causes the scanner unit 3 to descend. Once the open angle reaches approximately 25° (see FIG. 11), the operator twists the lower end side of the maintaining plate 4 to engage it with the lock unit 28 and places the maintaining plate 4 above the maintaining-plate support portion 29. Furthermore, when the operator slightly lifts up the scanner unit 3 and then causes it to descend, the maintaining plate 4 moves downward within the housing 21 to bring the scanner unit 3 into a closed state.

As described above, the housing structure, the printer 1, and the maintaining method according to the present embodiment make it possible to obtain the following effects.

With the present embodiment, the scanner unit 3 including the first protruding portion 61 is moved toward the +X direction to cause the first protruding portion 61 and the third support portion 54 to engage with each other. This enables the scanner unit 3 to be maintained in the opening posture at 45°. This eliminates the need of providing a member for supporting the scanner unit 3 at the end portion at the opening side, which makes it possible to facilitate access to the inside of the housing 21.

Furthermore, with the present embodiment, by moving the scanner unit 3 toward the +X direction, it is possible to cause the first protruding portion 61 and the third support portion 54 to engage with each other. This makes it easy to perform an operation of maintaining the scanner unit 3 in the opening posture at 45°.

In addition, with the present embodiment, when the open angle of the scanner unit 3 is smaller than 52°, the first protruding portion 61 and the third support portion 54 interfere with each other. Thus, movement of the scanner unit 3 toward the +X direction is restricted. This makes it possible to prevent the scanner unit 3 from unintentionally moving. Furthermore, movement of the scanner unit 3 is restricted by the first protruding portion 61 and the third support portion 54 used for engagement. This eliminates the need of adding a member for restriction, which makes it possible to simplify the structure.

In addition, with the present embodiment, the first protruding portion 61 and the third support portion 54 interfere with each other in a state in which the first protruding portion 61 engages with the third support portion 54. Thus, movement of the scanner unit 3 toward the +X direction is restricted. This makes it possible to prevent the scanner unit 3 from unintentionally moving to release the engagement. Furthermore, movement of the scanner unit 3 is restricted by the first protruding portion 61 and the third support portion 54 used for engagement. This eliminates the need of adding a member for restriction, which makes it possible to simplify the structure.

In addition, with the present embodiment, even in a state in which the scanner unit 3 moves toward the +X direction and the first protruding portion 61 and the third support portion 54 engage with each other, the first shaft section 61a fits into the through hole 51a, and the second shaft section 62a fits into the opening portion 52a. This makes it possible to stabilize the scanner unit 3 in the opening posture at 45°.

In addition, with the present embodiment, the first shaft section 61a serving as the rotational movement shaft of the scanner unit 3 protrudes from the first protruding portion 61 configured to engage with the third support portion 54. In other words, the scanner unit 3 and the housing 21 engage with each other in the vicinity of the rotational movement shaft. This makes it possible to more widely open the opening of the housing 21 in the opening posture at 45°, which further facilitates access to the inside of the housing 21.

Furthermore, since the first shaft section 61a and the first protruding portion 61 are integrally configured, it is possible to simplify the housing structure, as compared with a configuration in which the first shaft section 61a and the first protruding portion 61 are separately provided.

In addition, with the present embodiment, the cover member 31b of the scanner unit 3 comes into contact with the recessed portion 51b of the first support portion 51 and the recessed portion 52b of the second support portion 52. This makes it possible to restrict opening of the scanner unit 3 at 55° or more. Thus, it is possible to prevent the scanner unit 3 from unintentionally opening widely to cause the printer 1 to fall over.

In addition, the present embodiment makes it possible to maintain the scanner unit 3 in the opening posture at 45° and also possible to maintain the scanner unit 3 in the opening posture at 25° by the maintaining plate 4. This makes it possible to select an appropriate posture depending on details of work or the like. In particular, at the time of performing simple work, it is not necessary to open the scanner unit 3 more than necessary.

In addition, with the present embodiment, the maintaining plate 4 is detachable with respect to the housing 21. Thus, by detaching the maintaining plate 4, it is possible to further largely open the scanner unit 3.

Furthermore, with the present embodiment, the scanner unit 3 is able to be opened and closed with respect to the housing 21. The scanner unit 3 is heavier than a simple open-close cover. This makes it difficult for an operator to perform maintenance or the like while supporting it. In other words, as the scanner unit 3 is maintained in a predetermined opening posture, it is possible to improve workability at the time of performing maintenance or repair or the like.

The present embodiment basically has the configuration described above. However, it is possible to, for example, partially modify or omit the configuration as long as such modification or omission or the like does not deviate from the main points of the present disclosure. Furthermore, the present embodiment and other modification examples described below can be combined with each other and implement it as long as no technical contradiction arises due to the combination. Below, modification examples will be described.

The embodiment described above describes a configuration in which the scanner unit 3 that is able to rotate relative to the housing 21 is able to move along the rotational movement shaft. However, it may be possible to employ a configuration in which the housing 21 is able to move along the rotational movement shaft. In other words, the third support portion 54 provided integrally with the housing 21 may move together with the housing 21 along the rotational movement shaft.

In addition, the configuration is not limited to the configuration in which the first protruding portion 61 moves integrally with the scanner unit 3. It may be possible to employ a configuration in which the first protruding portion 61 is able to move relatively to the scanner unit 3 along the rotational movement shaft. In other words, it may be possible to employ a mode in which only the first protruding portion 61 is moved in order to cause the first protruding portion 61 and the third support portion 54 to engage with each other, rather than moving the entire scanner unit 3. Alternatively, it may be possible to employ a mode in which only the third support portion 54 is moved relatively to the housing 21.

In the embodiment described above, the scanner unit 3 includes the first shaft section 61a and the second shaft section 62a, and the housing 21 includes the through hole 51a and the opening portion 52a into which the first shaft section 61a and the second shaft section 62a fit, respectively. However, it may be possible to employ a configuration in which these are opposite to each other. In other words, it may be possible to employ a configuration in which the housing 21 includes the first shaft section 61a and the second shaft section 62a, and the scanner unit 3 includes the through hole 51a and the opening portion 52a.

Note that, when the scanner unit 3 includes the through hole 51a and the opening portion 52a, it is desirable that the through hole 51a and the opening portion 52a should be formed at the first protruding portion 61 of the scanner unit 3. With this configuration, the scanner unit 3 and the housing 21 engage with each other in the vicinity of the rotational movement shaft. Thus, as with the embodiment described above, it is possible to widely open the opening of the housing 21 in the opening posture at 45°, which further facilitates access to the inside of the housing 21. In addition, it is possible to simplify the housing structure, as compared with a case in which the through hole 51a and the opening portion 52a are formed at a member provided separately from the first protruding portion 61.

In the embodiment described above, the maintaining plate 4 is attachable to and detachable from the housing 21. However, the maintaining plate 4 may be attachable to and detachable from the scanner unit 3, or may be attachable to and detachable from both the housing 21 and the scanner unit 3. In other words, it is only necessary that the maintaining plate 4 is attachable to and detachable from at least one of the housing 21 and the scanner unit 3.

In the embodiment described above, when the open angle of the scanner unit 3 is less than 52°, the first protruding portion 61 and the third support portion 54 interfere with each other to restrict the movement of the scanner unit 3 toward the +X direction. However, the configuration is not limited to this configuration. For example, it may be possible to employ a configuration in which the movement is restricted by interference between members differing from the first protruding portion 61 and the third support portion 54.

In the embodiment described above, the first protruding portion 61 and the third support portion 54 interfere with each other in a state in which the first protruding portion 61 and the third support portion 54 engage with each other, whereby the movement of the scanner unit 3 in the +X direction is restricted. However, the configuration is not limited to this configuration. For example, it may be possible to employ a configuration in which the movement is restricted by interference between members differing from the first protruding portion 61 and the third support portion 54.

In the embodiment described above, the scanner unit 3 becomes movable toward the +X direction when the scanner unit 3 opens at not less than 52° serving as the first angle. In addition, by moving toward the +X direction, the scanner unit 3 is maintained in the first opening posture with the open angle being 45°. In this manner, the embodiment described above describes a mode in which the first angle (52°) at which movement toward the +X direction is possible is larger than the open angle (45°) in the first opening posture. However, the mode is not limited to this mode. In other words, the first angle may be equal to the open angle of the first opening posture, or may be smaller than the open angle of the first opening posture. For example, it may be possible to employ a mode in which the scanner unit 3 becomes movable toward the +X direction in a state of being opened at not less than the first angle that is smaller than the open angle of the first opening posture, and after movement, the scanner unit 3 is opened further larger so as to become the first opening posture.

The embodiment described above describes a configuration in which the scanner unit 3 is able to open and close relative to the housing 21. However, it may be possible to employ a configuration in which a unit differing from the scanner unit 3 opens and close, or a configuration in which a simple cover member opens and closes. In addition, the embodiment described above may have a configuration in which the original-document feeding device 32 is not provided in the scanner unit 3. In this case, an open-close cover configured to be able to open and close is provided at the upper surface of the unit main body 31 of the scanner unit 3.

In the embodiment described above, the printer 1 may be a device that performs recording on the medium, and may be a serial printer, a lateral printer, a line printer, a page printer, or the like. Furthermore, a printing method is not limited to the ink jet-type, and a thermal method, a dot impact-type, a laser method, or the like may be employed.

What is claimed is:

1. A housing unit comprising:
a housing including an opening; and
an opening/closing section configured to rotate relative to the housing with a rotational movement shaft being a center to switch a posture to a closing posture and a first opening posture, the closing posture being a posture in which the opening of the housing is closed, the first opening posture being a posture in which the opening of the housing is opened, wherein
the opening/closing section includes a first engaging portion,
the housing includes a second engaging portion,
by opening the opening/closing section at a first angle or more from the closing posture, the first engaging portion or the second engaging portion moves in a direction along the rotational movement shaft to enable the first engaging portion and the second engaging portion to engage with each other, and
upon the first engaging portion and the second engaging portion engaging with each other, the opening/closing section is maintained in the first opening posture.

2. The housing unit according to claim 1, wherein
the first engaging portion is provided at the opening/closing section, and together with the opening/closing section moves in a direction along the rotational movement shaft.

3. The housing unit according to claim 2, wherein
in a state in which the opening/closing section is not opened at the first angle or more from the closing posture, the first engaging portion and the second engaging portion interfere with each other to restrict movement of the opening/closing section in a direction along the rotational movement shaft.

4. The housing unit according to claim 2, wherein
in a state in which the first engaging portion and the second engaging portion engage with each other, the first engaging portion and the second engaging portion interfere with each other to restrict movement of the opening/closing section in a direction along the rotational movement shaft.

5. The housing unit according to claim 2, wherein
one of the housing and the opening/closing section includes a shaft portion that constitutes the rotational movement shaft,
the other one of the housing and the opening/closing section includes a bearing unit into which the shaft portion fits, and
in a state in which the opening/closing section moves in a direction along the rotational movement shaft and the first engaging portion and the second engaging portion engage with each other, the shaft portion fits into the bearing unit.

6. The housing unit according to claim 5, wherein
the opening/closing section includes the shaft portion, and the shaft portion protrudes from the first engaging portion.

7. The housing unit according to claim 5, wherein
the opening/closing section includes the bearing unit, and
the bearing unit is formed at the first engaging portion.

8. The housing unit according to claim 1, further comprising:
a restricting unit configured to restrict opening of the opening/closing section at a second angle or more, the second angle being larger than the first angle.

9. The housing unit according to claim 1, further comprising:
a holding unit configured to maintain the opening/closing section in a second opening posture in which an angle of the opening/closing section is smaller than the first opening posture.

10. The housing unit according to claim 9, wherein
the holding unit is coupled to both the opening/closing section and the housing, and
the holding unit is attachable to and detachable from at least one of the opening/closing section and the housing.

11. A recording device comprising:
the housing unit according to claim 1; and
a recording unit accommodated in the housing and configured to perform recording on a medium.

12. The recording device according to claim 11, wherein the opening/closing section is a reading device configured to read an original document.

13. A method of maintaining an opening/closing section in a first opening posture, the opening/closing section being configured to rotate relative to a housing including an opening with a rotational movement shaft being a center to switch a posture to a closing posture and the first opening posture, the closing posture being a posture in which the opening of the housing is closed, the first opening posture being a posture in which the opening of the housing is opened, the method including:
opening the opening/closing section at a first angle or more from the closing posture,
moving the opening/closing section in a direction along the rotational movement shaft in a state in which the opening/closing section is opened at the first angle or more, and
causing a first engaging portion and a second engaging portion to engage with each other in a state in which the opening/closing section is moved in a direction along the rotational movement shaft, the first engaging portion being included in the opening/closing section, the second engaging portion being included in the housing.
